(19) United States
(12) Patent Application Publication
(10) Pub. No.: US 2001/0010039 A1
(43) Pub. Date: Jul. 26, 2001

(54) Method and apparatus for mandarin chinese speech recognition by using initial/final phoneme similarity vector

(75) Inventor: Chung-Ho Yang, Towliu City (TW)

Correspondence Address: GREENBLUM & BERNSTEIN, 1941 ROLAND CLARKE PLACE, RESTON, VA, 20191

(73) Assignee: Matsushita Electrical Industrial Co., Ltd.

(21) Appl. No.: 09/731,716

(22) Filed: Dec. 8, 2000

(30) Foreign Application Priority Data
Dec. 10, 1999 (JP) 11-351452

(51) Int. Cl. G10L 15/08; G10L 15/00; G10L 15/12

(52) U.S. Cl. 704/239

(57) ABSTRACT

Apparatus for Mandarin Chinese speech recognition by using initial/final phoneme similarity vector, for improving the Chinese speech recognition accuracy and downsizing the needed memory is provided. A Mandarin Chinese speech recognition apparatus comprises a speech signal filter for receiving a speech signal and creating a filtered analogue signal, an analogue-to-digital (A/D) converter connected to the speech signal to a digital speech signal, a computer connected to the A/D converter for receiving and processing the digital signal, a pitch frequency detector connected to the computer for detecting characteristics of the pitch frequency of the speech signal thereby recognizing tone in the speech signal, a speech signal pre-processor connected to the computer for detecting the endpoints of syllables of speech signals thereby defining a beginning and ending of a syllable, and a training portion connected to the computer for training an initial part PSV model and a final part PSV model and for training a syllable model based on trained parameters of the initial part PSV model and the final part PSV model.

### BACKGROUND OF THE INVENTION

1. Field of the Invention

The present invention related to an apparatus of Chinese recognition by using Initial/Final phoneme similarity vector. The purpose of the invention is to improve recognition accuracy and downsize the demanded memory, which can be built on single DSP (Digital Signal Processing) chip for Mandarin Chinese speech recognition system. More particularly, the invention is focused on a new methodology for not only improving the Chinese speech recognition rate based on Chinese Initial/Final phoneme similarity but also downsizing the needed memory.

2. Description of the Prior Art

From the past more than twenty years, the research and development of Mandarin speech recognition techniques have been very prosperous discussed not only in the academic fields but also in commercialization-oriented private companies. As we can easily understand, human speech is generated according to a shape of vocal tract and its temporal transition. The shape of vocal tract, which depends on the shape or size of the vocal organ, inevitably shows individual differences. On the other hand, the pattern of time sequence of the vocal tract, which also depends on an uttered word that, shows a small individual difference. Therefore, features of utterance should be divided into two factors: the shape of the vocal tract and its temporal pattern. The former shows large difference from speaker to speaker whereas the latter one shows small difference. So if the difference based on the shape of the vocal tract is somehow normalized, the speech of specified speakers can be recognized using only the utterances of a small number of speakers. The difference in the shape of the vocal tracts causes different frequency spectra. One of the methods to normalize the spectral difference among speakers is to classify voice input by matching it with phoneme templates which are made for unspecified speakers. This operation provides similarity, which does not depend very much on the differences among speakers. Meanwhile, the temporal pattern of vocal tract is considered to have small individual difference.

The motivation for understanding the mechanism of speech production lies in the fact that speech is the human being's primary means of communication. There are areas such as non-linearity of vocal fold vibration, vocal-tract articulator dynamics, knowledge of linguistics rules, and acoustic effects of coupling of the glottal source and vocal tract that continue to be studied. The continued pursuit of basic speech analysis has provided new and more realistic means of performing speech synthesis, coding, and recognition. From the historical progression, one of the first all-electrical networks for modeling speech sounds was developed by J. Q. Stewart (1922). From the ancient system for speech processing to the newest development, we have known speech sounds in terms of the position and movement of the vocal-tract articulators, variation in their time waveform characteristics, and frequency domain properties such as format location and bandwidth. The inability of the speech production system to change instantaneously is due to the requirement of finite movement of the articulators to produce each sound. Unlike the auditory system, which has evolved solely for the purpose of hearing, organs used in speech production are shared with other functions such as breathing, eating, and smelling. For the purpose of human communication, we shall only be concerned with the acoustic signal produced by talker. In fact, there are many parallels between human and electronic communications. Due to the limitations of the organs for human speech production and the auditory system, typical human speech communication is limited to a bandwidth of 7-8 kHz.

In the research of vocal tract for computation and science of understanding the relationship between the physical speech signal and the physiological mechanisms, i.e. the human vocal tract mechanism, which produces the speech and the human hearing mechanism, which perceives the speech. That can be named as “acoustics.” The newest approach evaluates human speaking and hearing physical systems and, in digitalization, those human communication signals to be parameters, such as acoustical features extraction. The human acoustical features are usually very unique-depends. That is, everyone hold his/her own acoustical features, particularly.

Usually standard patterns for speaker-independent speech recognition are made by statistically processing speech data of speakers. There are several matching methods: for example, a method using the statistical distances measure, and a method applying the neural net models, such as ROC Pat. No. 303452; and Hidden Markov Model (HMM), such as ROC Pat. No. 283774 and 269036. Especially, numbers of successful HMM are reported using the continuous mixture Gaussian density models. With these methods, spectral parameters are used in speech recognition as a feature parameter and an enormous number of speakers are generally required for training. It also costs very large memory in order to get high recognition rate. If the standard patterns for speaker independent speech recognition can be produced from a small number of speakers, the size of computation will be much smaller than usual. Therefore, human power and computation are saved and speech recognition technique can be easily handled to various applications. For the purpose mentioned above, we proposed our invention of speech recognition apparatus using the similarity vectors as feature parameters. In this method, word templates trained with a small number of speakers yield high recognition rates in speaker-independent recognition. To realize the speech recognition technology in real applications, speech recognizer must be robust to noisy environments and spot intended words from background noise and unintended utterances. Furthermore, speech recognizer must retain high quality performance on portable devices. For these reasons, our invention was focused on small-size programming code but high accuracy rate for portable device which can be built-in a Chinese speech recognition system.

### SUMMARY OF THE INVENTION

There are many algorithms and methodologies have been applied for English speech recognition, however, whereas the Chinese has some crucial properties in its expression of speech, which are very different with Western Languages. The differences, for example, are known as tone information and monosyllable sound pattern for each character of Chinese. In term of the characteristic of Chinese speech, Chinese spoken language is a bi-syllabic language where one character consists of one consonant or nasal in the front one vowel at the end. The front consonant is called the “Initial” while the ending vowel is called “Final”. The Initial has short duration and is affected by the Final while the Final has a transient part in the front. For instance, Chinese characters like: [symbol] (g+uan1) or [symbol] (s+ing1) and so on. The middle part of Final is steady and is the same for the whole set of Final group. The ending part of each Final is characterized by an ending consonant whether voiced or unvoiced. Mandarin has a total of 21 Initials and one null Initial and 36 Finals that include middle transient and null Final which compose the whole. If the five tones are not being considered, there are 409 Mandarin syllable sets. Combining tones and phonemes, there are a total number of 1345 different syllables in Mandarin. Another characteristic of Chinese spoken language is Chinese homonyms of which tonal nature where different tones with the same phonemes can represent different characters.

To get high accuracy recognition rate for Chinese spoken language, the process of extracting relevant information from the Chinese speech signal in an efficient, crucial and robust manner is the key technology. There are many approaches for Chinese speech recognition include the form of spectral analysis used to characterize the time-varying properties of the speech signal as well as various types of signal pre-processing and post-processing to make the speech signal robustly to the recording environment. They are usually connecting to Digital Signal Processing (DSP) skill and many mathematical models and formulae, such as DFT (or FFT), FIR, z-transform, LPC, neural network and Hidden Makov Model. Though such many sorts of mathematical models have been submitted to apply in Chinese speech recognition, it seems that those methods still can not improve recognition accuracy well from a small number of trained speaker database.

In the basic conventional Initial-Final structural based approach for Chinese speech recognition, it uses the Initial-Final characteristic of Chinese spoken language. This conventional approach uses this method to model input syllable as a concatenation of Initial and Final. However, using this approach does not imply that the input syllable will be segmented into two parts explicitly. Using such Initial-Final structure modeling, the whole set of syllables must be recognized by identifying Initials and Finals. For systems employing Initial-Final characteristics, recognition of initials and finals is the vital part. In the early stage, several authors, such as that disclosed in ROC Pat. No. 273615, 278174 (U.S. Pat. No. 5,704,004) and 219993 proposed methodologies in separate recognition of Initials and Finals. U.S. Pat. No. 5,704,004 is the counterpart of ROC Pat. 278174. A syllable is first segmented in two parts and recognized separately. That is, the Initial is first segmented from the syllable and classified into voiced and unvoiced by extracting features like zero-crossing rate, average energy and syllable duration. Then, a feature codebook can be set up by using these feature vectors. Recognition can be done by finite-state vector quantization. In those conventional systems, the final is known in advance. Therefore, consonant classification can be done within the recognized Final group. The recognition accuracy of this conventional approach is merely up to 93% (ROC Pat. No. 273615) according to empirical result. Meanwhile, those approaches have to build a large speech corpus from numerous speakers for its processing.

Therefore, we propose our invention to improve not only in recognition rate but also our apparatus of Chinese speech recognition system that can reduce the size of the programming code. This invention is for developing a high accuracy speaker-independent Chinese speech recognition system using the similarity vectors as feature parameters. An empirical result of word recognition rate is 97.5% with 106 cities cover Taiwan based on noisy environment. Our invention of accuracy rate in Chinese speech recognition has much higher than conventional methods (such as ROC Pat. No. 273615, 278174). We have got more 4.5% higher than any other traditional methods.

The object of this invention is to provide apparatus for Mandarin Chinese speech recognition by using initial/final phoneme similarity vector, for improving the Chinese speech recognition accuracy and downsizing the needed memory.

The object of this invention is also to provide the method of Mandarin Chinese speech recognition by using initial/final phoneme similarity vector.

A Mandarin Chinese speech recognition method comprises the step of training a Phoneme Similarity Vector (PSV) model on the initial part to create an initial part model having trained initial part model parameters, the step of training a PSV on the final part to create a final part model having trained final part model parameter, the step of training a PSV on the training speech syllable to create a syllable model using the trained initial part parameter values and the trained final part parameter values as starting parameters for the syllable model, the step of operating on an object speech sample with the syllable model, the step of recognizing the object speech sample as an object speech syllable based on a degree of match of the object speech sample to the syllable model, and the step of representing the object speech sample as a Chinese character in accordance with the object speech syllable.

A Mandarin Chinese speech recognition method as in claim 1 further comprises the step of training a Dynamic Time Warping (DTW) on a sequence of Chinese characters as used in context to create a Chinese language model, the step of operating on a sequence of object speech syllables in the object speech sample with the Chinese language model, the step of representing the object speech sample as a Chinese character sequence in accordance with a match of the sequence of object speech syllables to the Chinese language model, and the step of representing the object speech sample as a Chinese character sequence in accordance with a sequence of matches to the object speech syllables.

A Mandarin Chinese speech recognition apparatus comprises, a speech signal filter for receiving a speech signal and creating a filtered analogue signal, an analogue-to-digital (A/D) converter connected to the speech signal to a digital speech signal, a computer connected to the A/D converter for receiving and processing the digital signal, a pitch frequency detector connected to the computer for detecting characteristics of the pitch frequency of the speech signal thereby recognizing tone in the speech signal, a speech signal pre-processor connected to the computer for detecting the endpoints of syllables of speech signals thereby defining a beginning and ending of a syllable, and a training portion connected to the computer for training an initial part PSV model and a final part PSV model and for training a syllable model based on trained parameters of the initial part PSV model and the final part PSV model.

### BRIEF DESCRIPTION OF THE DRAWINGS

These and other objects and features of the present invention will become clear from the following description taken in conjunction with the preferred embodiments thereof with reference to the accompanying drawings throughout which like parts are designated by like reference numerals, and in which:

FIG. 1 shows a system block diagram of a preferred embodiment in the present invention;

FIG. 2 shows a schematic diagram illustrating the processing procedure of INPUT PORTION of the present invention;

FIG. 3 shows a schematic diagram illustrating the processing procedure of ACOUSTIC ANALYSIS PORTION of the present invention;

FIG. 4 shows a schematic diagram illustrating the processing procedure of SIMILARITY CALCULATION PORTION of the present invention;

FIG. 5 shows a detailed processing diagram illustrating the filtering and Analogue to Digital Signal converting of the present invention;

FIG. 6 shows an electronic circuit diagram of Analogue to Digital converting of the present invention;

FIG. 7 shows a detailed processing diagram illustrating the BANDPASS filter of the present invention;

FIG. 8 shows a detailed processing diagram illustrating the LPC analysis block of the present invention;

FIG. 9 shows a processing procedure and its algorithms illustrating the similarity calculation and similarity parameter generation of the present invention;

FIG. 10 shows a processing procedure of the RECOGNITION PORTION of the present invention;

FIG. 11 shows a table illustrating the Chinese basic syllable and tone information for phoneme modeling of the present invention;

FIGS. 12, 13 and 14 show tables illustrating the Chinese detailed phoneme information for phoneme modeling of the present invention;

FIG. 15 shows a table illustrating the dynamic programming of the present invention; and

FIG. 16 shows the 106 city names for empirical word templates.

### DETAILED DESCRIPTION OF THE PREFERRED EMBODIMENTS

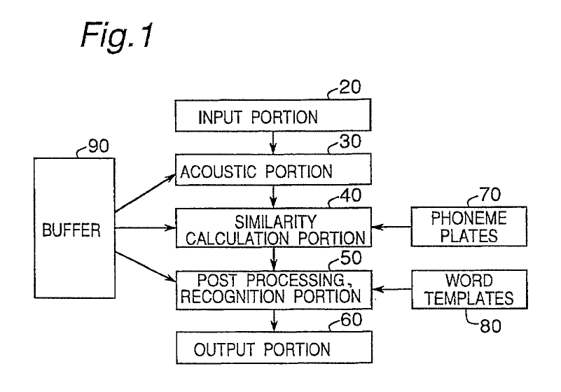

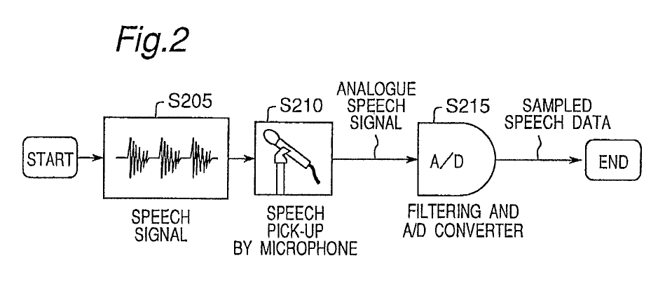

The present invention overcomes the deficiency and limitations of the prior art with a system and method for recognizing Mandarin Chinese speech with small number of training speakers. There are five portions in our speech recognition apparatus, including INPUT PORTION 20, ACOUSTIC ANALYSIS PORTION 30, SIMILARITY CALCULATION PORTION 40, RECOGNITION PORTION 50, and OUTPUT PORTION 60. The present invention advantageously implements in a size-intensive device when determining the Initial and Final of a syllable to identify the phonetic information of a Chinese word. Referring now to FIG. 1, the architecture of our invention for Chinese speech recognition is illustrated. In our apparatus, INPUT PORTION 20 deals the human speech signal input. Referring now to FIG. 2, a basic block diagram of INPUT PORTION 20 is shown. Because human speech is a kind of analogue signal, the signal from microphone input have to be converted into digital signals in order to further computation by computer (S205 and S210). In general, the frequency of human speech is on the range of 125 Hz˜3.5 KHz, so a low pass filter has to be built in front of A/D converter to get real human speech signal and filter out the redundant noise signal from real environment (S215).

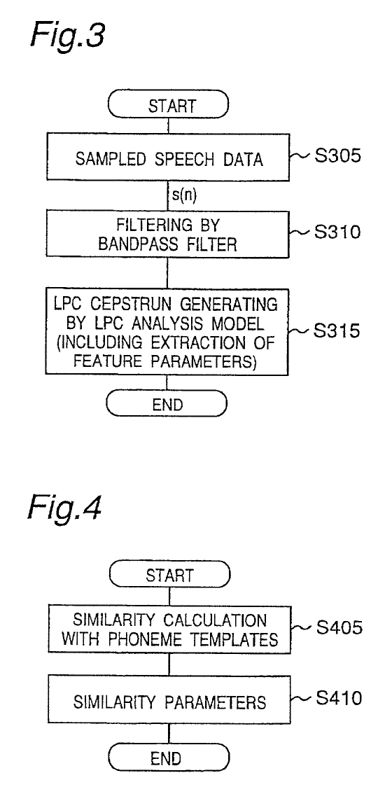

Referring now to FIG. 3, a basic block diagram of ACOUSTIC ANALYSIS PORTION 30 is shown. In this acoustic analysis portion 30, there are three specific processing blocks (S305, S310 and S315), including band-pass filter, extraction of feature parameter and LPC analysis model.

After the acoustic analysis portion 30 is calculated, referring now to FIG. 4, the block diagram illustrates the SIMILARITY CALCULATION PORTION 40.

Our apparatus begins with a user creating a speech signal to accomplish a given task. In the second step, the spoken output is first recognized in that the speech signal is decoded into a series of phonemes that are meaningful according to the phoneme templates. The acoustic analysis portion 30 analyses speech inputs and the extracted LPC (Linear Predictive Coding) cepstrum coefficients and delta power. The extracted parameters are matched with many kinds of phoneme templates, and static phoneme similarity and the first order regression coefficients of phoneme similarity are calculated in the similarity calculation portion 40. After that, the time sequence of those number of phoneme templates to define a dimensional similarity coefficient vectors and regression coefficient vectors can be obtained. In the similarity calculation portion 40, mahalanobis′ distance algorithm is employed for distance measure, where covariance matrixes for all of the phonemes are assumed to be the same. The meaning of the recognized words is obtained by the post processor that uses a dynamic programming to match inputted word with the real word and the word having been previously recognized by phoneme similarity calculation. Consequently, the post processing make a decision according to the previous phoneme result that reduces the complexity of all the recognition model. Finally, the recognition system responds to the user in the form of a voice output, or equivalently, in the form of the requested action being performed, with the user being prompted for more input.

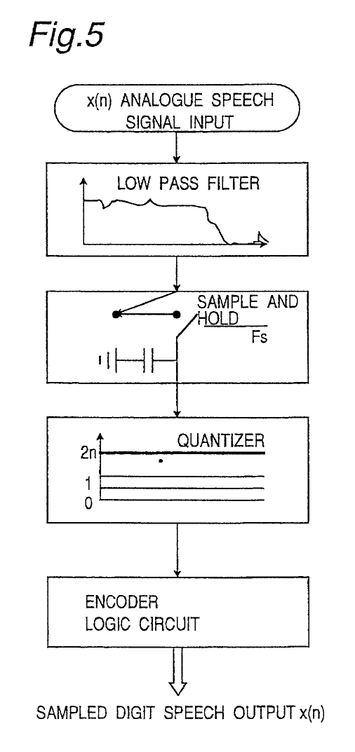

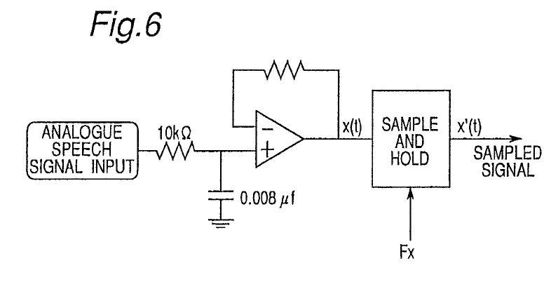

The follows, we are going to explicate detailed processing of our apparatus not only in the explicit of the each procedure but also the algorithm will be described. FIG. 5 illustrates the processing procedure that explicates how the analogue to digital signal converting works. Most signals in nature are in analogue form, necessitating an analogue-to-digital conversion process, which involve the following steps. 1) The analogue input signal. This signal is continuous in both time and amplitude. 2) The sampled signal. This signal is continuous in amplitude but defined only at discrete points in time. 3) The digital signal, x(n) (n=0, 1, . . . ) This signal exists only at discrete points in time and at each time point can only have one of 2^{B} values. Referring now to FIG. 6, the electronic circuit of A/D converter can be presented.

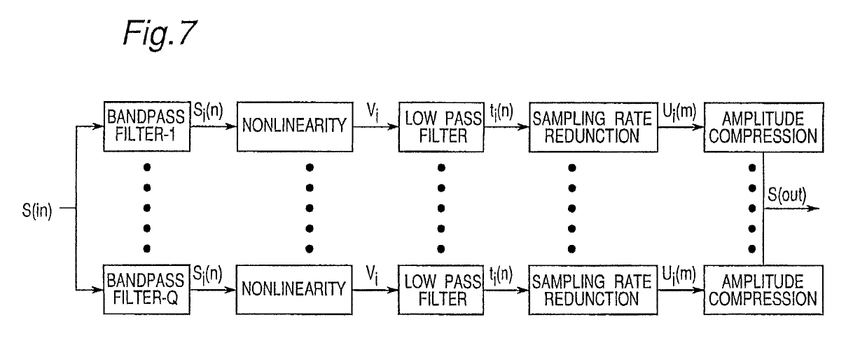

FIG. 7 illustrates the detailed processing steps of band-pass filter of the ACOUSTIC ANALYSIS PORTION. The sampled speech signal, s(n), is passed through a bank of Q band-pass filters, giving the signals

$$\begin{matrix}{S}_{i} ( n ) = s ( n ) * {h}_{i} ( n ) , 1 \leq i \leq Q \\ = {\sum }_{m = 0}^{{M}_{i } - 1} {h}_{i} ( m ) s ( n - m )\end{matrix}$$

where we have assumed that the impulse response of the i^{th} band-pass filter is hᵢ(m) with a duration of Mᵢ samples. Meanwhile, assume that the output of the i^{th} band-pass filter is a pure sinusoid at frequency wᵢ, that is, Sᵢ=α₁ sin(wᵢn). If we use a full-wave rectifier as the nonlinearity, that is,

ƒ(Sᵢ(n))=Sᵢ(n) for Sᵢ(n)≧0

=−Sᵢ(n) for Sᵢ(n)<0

then we can represent the nonlinearity output as

Vᵢ(n)=ƒ(sᵢ(n))=Sᵢ(n)·W(n)

where W(n)=+1 if Sᵢ(n)≧0

=−1 if Sᵢ(n)<0

After the nonlinearity processing, the role of the low-pass filter is to filter out the higher frequency. Although the spectrum of the low-pass signal is not a pure DC impulse, the instead the information in the signal is contained in a low-frequency band around DC. Thus an important role of the final low-pass filter is to eliminate the undesired spectral peaks. In the sampling rate reduction step, the low-pass filtered signals, tᵢ(n), are resampled at a rate on the order of 40-60 Hz, and the signal dynamic range is compressed using an amplitude compression scheme. At the output of the analyzer, if we use a sampling rate of 50 Hz and we use a 7 bit logarithmic amplitude compressor, we get an information rate of 16 channels times 50 (samples per (second per channel)) times 7 (bits per sample), or 5600 (bits per second). Thus, for this simple example, we have achieved about a 40-to-1 reduction in bit rate.

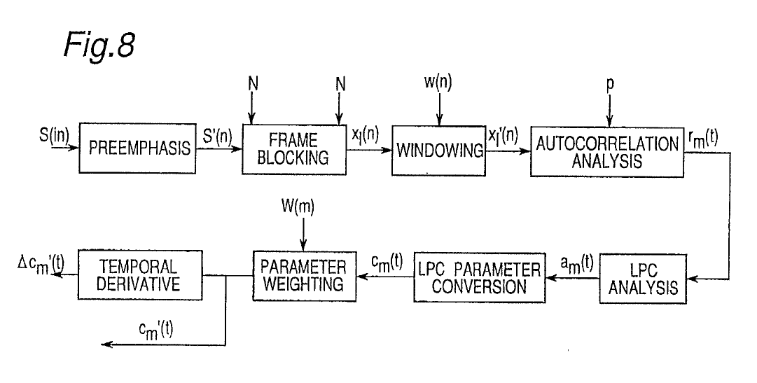

The LPC analysis model of the ACOUSTIC ANALYSIS PORTION is illustrated in FIG. 8. The LPC method has been used in a large number of recognizers for a long time. In particular, the basic idea behind the LPC model is that a given speech sample at time n, S(in), in the preemphasis box, can be approximated as a linear combination of the past p speech samples, such that

S′(n)≅α₁S(n−1)+α₂S(n−2)+ . . . +αₚS(n−p)

where the coefficients α₁, α₂, . . . , αₚ are assumed constant over the speech analysis frame. In our apparatus, we define the value α₁, α₂, . . . , αₚ as 0.95. In the step of the Frame Blocking, the previously dealing of the preemphasized speech signal, S′(n), is blocked into frames of N samples, with adjacent frames being separated by M samples. Assume we denote the l^{th} frame of speech by xₗ(n), and there are L frames within the entire speech signal, then

xₗ(n)=S′(Ml+n), n=0, 1, . . . , N−1, l=0, 1, . . . , L−1

In our apparatus, the values for N and M are 300 and 100, the values corresponding to the sampling rate of the speech are 8kHz. After that, the next step in the processing is to window each individual frame so as to minimize the signal discontinuities at the beginning and end of each frame. In our system, we define the window as w(n), 0≦n≦N−1, and then the result of windowing is the signal

xₗ′=xₗ(n)w(n), 0≦n≦N−1 .

The window in our apparatus used for the autocorrelation method of LPC is the Hamming window, which has the form

$$w ( n ) = 0.54 - 0.46 cos ( \frac{2 π n}{N - 1} ) , 0 \leq n \leq N - 1$$

Following, an autocorrelation analysis should be processed. Each frame of windowed signal is next autocorrelated to give

$${r}_{l} ( m ) = {\sum }_{n = 0}^{N - 1 - m} {x}_{l}^{′} ( n ) {x}_{l}^{′} ( n + m ) , m = 0 , 1 , … , p$$

where the highest autocorrelation value, p, is the order of the LPC analysis. The next processing stage is the LPC analysis, which converts each frame of p+1 autocorrelations into an “LPC parameter set,” in which the set might be the LPC coefficients, the reflection coefficients, the log area ratio coefficients, and the cepstral coefficients. In our system, we use Durbin's method and can formally be given as the following algorithm:

$${E}^{( 0 )} = r ( 0 )$$

$${k}_{i} = \{ r ( i ) - {\sum }_{y = 1}^{L - 1} £ {\backslash}_{j}^{i - 1} r ( \vert i - j \vert ) \} / {E}^{( i - 1 )} , 1 \leq i \leq p$$

$${α}_{i}^{( i )} = {k}_{i}$$

$${α}_{j}^{( i )} = {α}_{j}^{( i - 1 )} - {k}_{i} {α}_{i - j}^{i - 1}$$

$${E}^{( i )} = ( 1 - {k}_{i}^{2} ) {E}^{( i - 1 )}$$

The set of equations above can be calculated recursively for i=1, 2, . . . , p, and the final solution is given as αₘ=LPC coefficients=αₘ^{(p)}, 1≦m≦p.

After having obtained the LPC analysis coefficients have been done, LPC Parameter is converted to Cepstral Coefficients whose processing is going to be dealt. This very important LPC parameter set, which can be derived directly from the LPC coefficient set, is the LPC cepstral coefficients, cₘ. The recursion used is:

$${C}_{0} = ln {δ}^{2}$$

$${C}_{m} = {a}_{m} {\sum }_{k = 1}^{m - 1} ( \frac{k}{m} ) {C}_{K} {a}_{m - k} , 1 \leq m \leq p$$

$${C}_{m} = {\sum }_{k = 1}^{m - 1} ( k / m ) {C}_{k} {a}_{m - k} , m > p$$

Where δ² is the gain term in the LPC model. So until the description above, we have got the input vector C composed of LPC cepstrum coefficients and delta power in many frames.

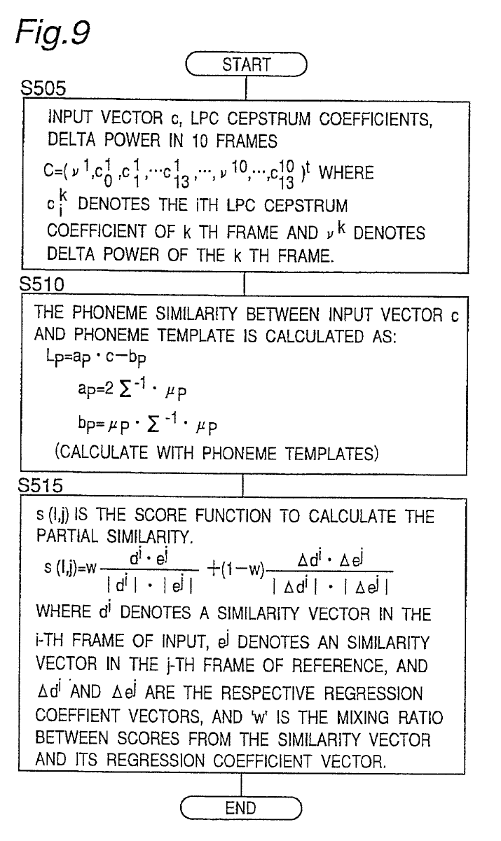

FIG. 9 illustrates the detailed processing steps and algorithms for the similarity calculation portion of our apparatus. In this similarity calculation portion, we employ the simplified Mahalanobis's distance for distance measure, where covariance matrixes for all the phonemes are assumed to be identical. Input vector c is composed of LPC cepstrum coefficients, delta power in 10 frames. As the first box of FIG. 9 mentioned, the input vector c is expressed as:

c=(v¹ , c₀¹, c₁¹, . . . , V¹⁰, . . . , c₁₃¹⁰)^{t}

where cᵢ^{k} denotes the i-th LPC cepstrum coefficient of the k-th frame and v^{k} denotes delta power of the k-th frame.

The phoneme similarity between input vector c and phoneme template (phoneme p) is calculated as

$${L}_{p} = {a}_{p} \cdot c - {b}_{p}$$

$${a}_{p} = 2 {\sum }^{- 1} \cdot {μ}_{p}$$

$${b}_{p} = {μ}_{p} \cdot {\sum }^{- 1} \cdot {μ}_{p}$$

where μₚ is a mean vector of phoneme p, and Σ is the covariance matrix.

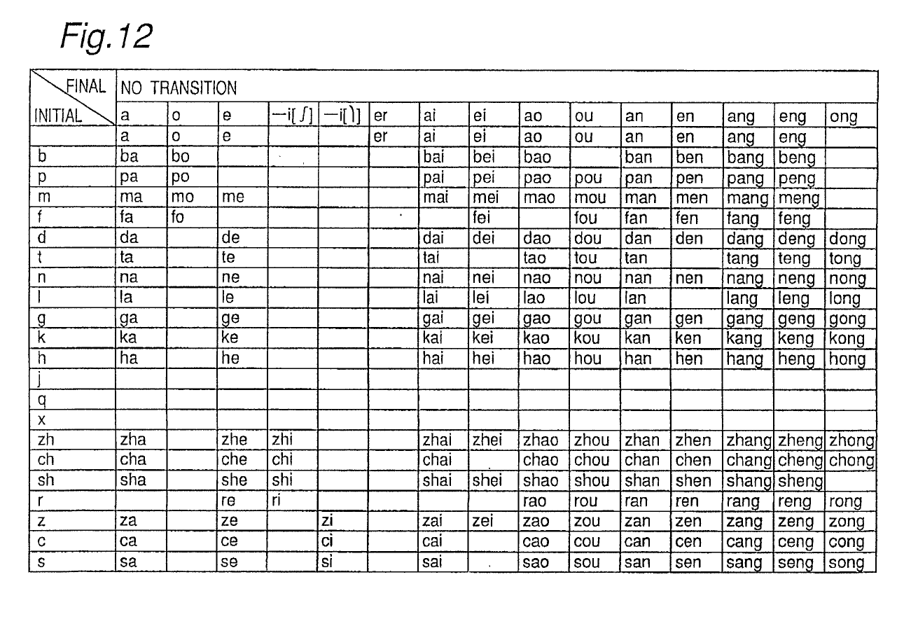

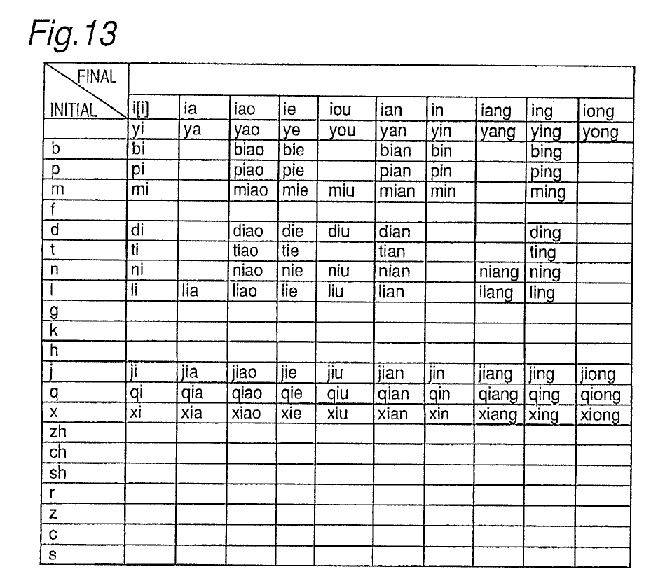

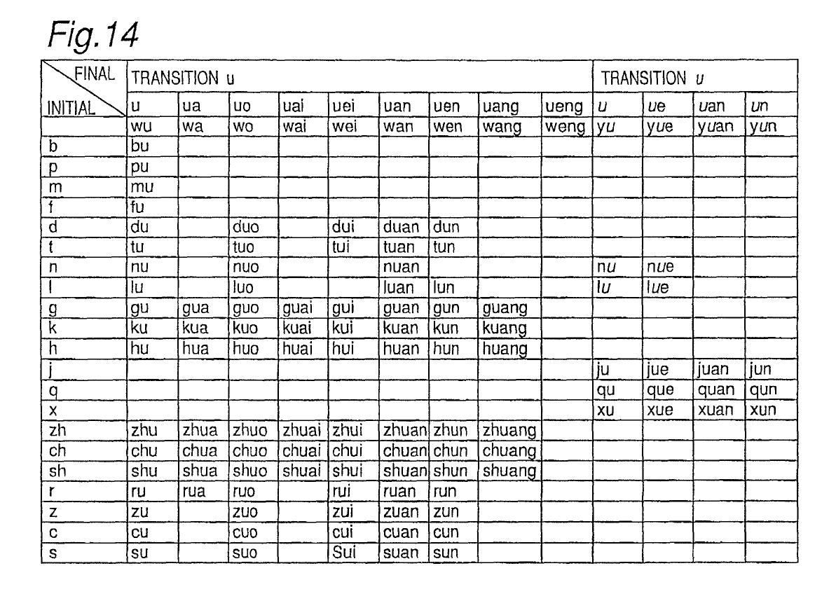

After the static phoneme similarities are obtained, regression coefficients of the phoneme similarities are computed using static phoneme similarities over 50 msec. The word templates are produced by concatenating sub-word units such as CV and VC obtained from a few speakers' speech. Especially, in the similarity calculation portion, it includes phoneme-templates that consist of a Chinese Initial field and a Chinese Final one. For Chinese syllables that have both an Initial and a Final, an Initial field stores a textual representation of the Initial and a Final field stores a textual representation of the Final. There are 409 kinds of sub-word units. Basic Chinese phonetic symbol can be found in FIG. 11, FIG. 12, FIG. 13, and FIG. 14. According, the similarity parameter can be obtained by the calculation of s(i, j), which is the score function to calculate the partial similarity (s515).

$$s ( i , j ) = w \frac{{d}^{i} \cdot {e}^{j}}{\vert {d}^{i} \vert \cdot \vert {e}^{j} \vert} + ( 1 - w ) \frac{Δ {d}^{i} \cdot Δ {e}^{j}}{\vert Δ {d}^{i} \vert \cdot \vert Δ {e}^{j} \vert}$$

where dⁱ denotes a similarity vector in the i-th frame of input, e^{j} denotes a similarity vector in the j-th frame of reference, and Δdⁱ and Δe^{j} are the respective regression coefficient vectors, and ‘w’ is the mixing ratio between scores from the similarity vector and its regression coefficient vector. The trajectories of the similarity are regression coefficients are averaged for each sub-word unit and stored in a sub-word dictionary. The main invention of our apparatus is that when speech pattern input into the microphone, the time sequences of similarity vector and regression coefficients vector for each frame are calculated as feature parameters.

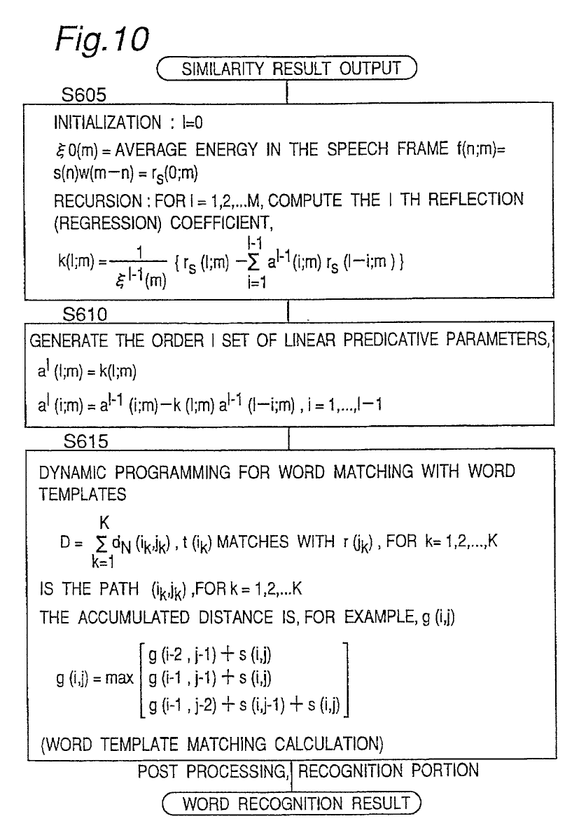

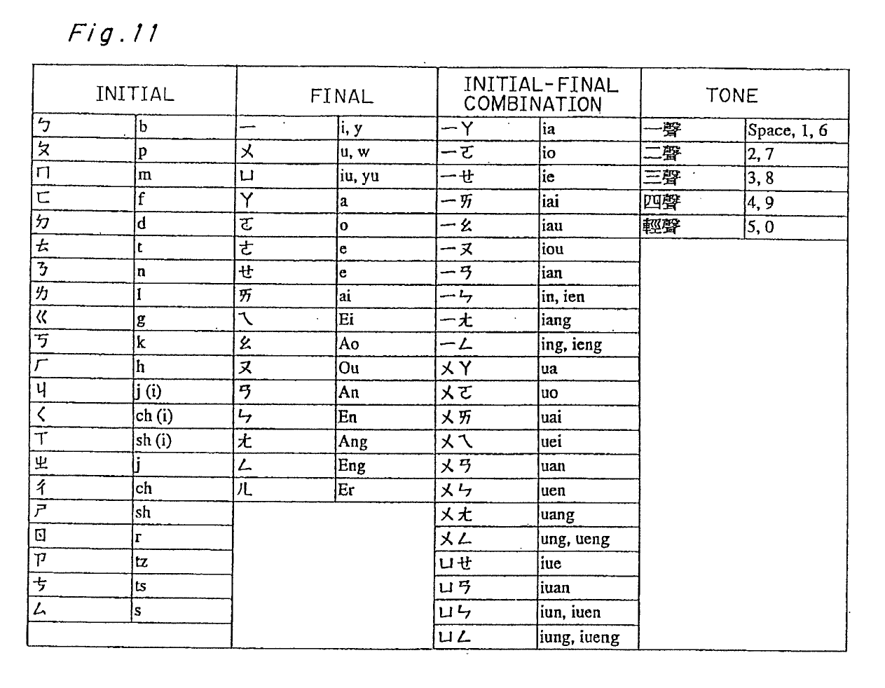

Referring now to FIG. 10, the RECOGNITION PORTION is shown. These time sequences of the feature parameters of input speech and reference in the dictionary are compared with Dynamic Programming (DP) matching and the most similar word is selected as a recognition results. In this portion, we employ the most widely used technology that is well known as “Dynamic time Warping (DTW)” for our word template recognition processing. DTW is fundamentally a feature-matching scheme that inherently accomplishes “time alignment” of the sets of reference and test features through a DP procedure. By time alignment we mean the process by which temporal regions of the test utterance are matched with appropriate regions of the reference utterance. The need for time alignment arises not only because different utterances of the same word will generally be of different duration, but also because phonemes within words will also be of different duration across utterances. In the third box of FIG. 10, that is, in S615 the Dynamic Programming for word matching with word templates algorithms are shown as:

$$D = {\sum }_{k = 1}^{K} {d}_{N} ( {i}_{k} , {j}_{k} ) ,$$

t(iₖ) matches with r(jₖ),

for k=1, 2 . . . , K

is the path (iₖ, jₖ), for k=1, 2, . . . , K

the accumulated distance is, for example, g(i, j)

$$g ( i , j ) = max [ \begin{matrix}g ( i - 2 , j - 1 ) + s ( i , j ) \\ g ( i - 1 , j - 1 ) + s ( i , j ) \\ g ( i - 1 , j - 2 ) + s ( i , j - 1 ) + s ( i , j )\end{matrix} ]$$

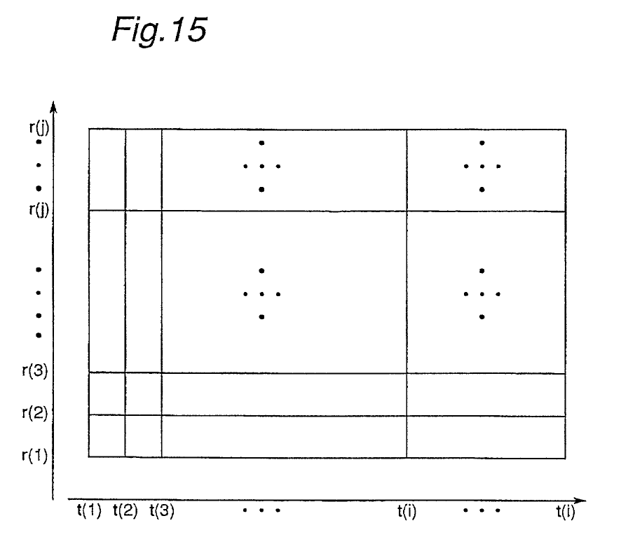

FIG. 15 illustrates the test and reference feature vectors associated with the i and j coordinates of the search grid, respectively.

Chinese phoneme templates of our apparatus for Chinese speech recognition are trained by 212 word sets spoken by 20 speakers. 10 male and 10 female. They are made from time-spectral patterns around distinctive frames as epoch frame. For example, the epoch frames of vowels are in the middle of duration and those of unvoiced consonant are at the end of duration.

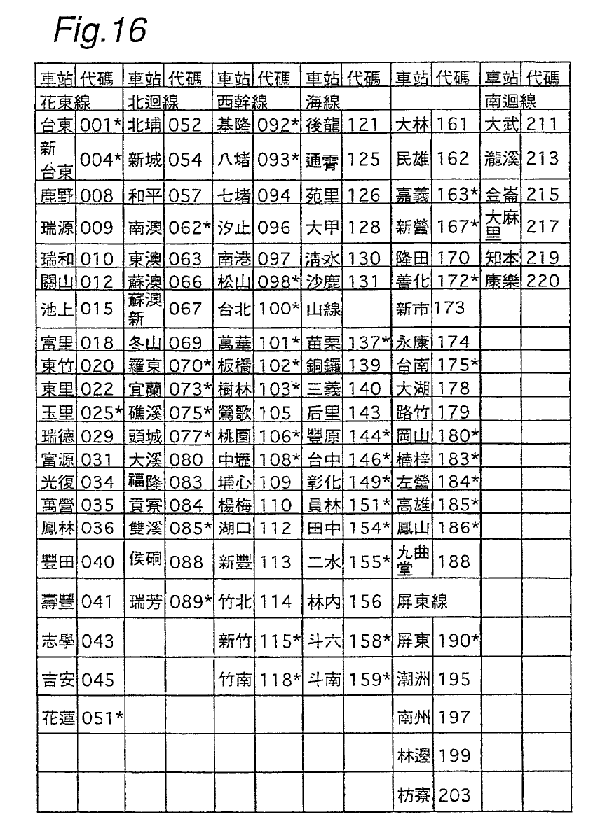

In the empirical result, based on 106 city names cover Taiwan of FIG. 16, the table as following shows the accuracy of traditional LPC cepstrum coefficient recognition rate.

| Precision of Feature Parameters | 32 bit | 8 bit | 6 bit | 4 bit |
|---|---|---|---|---|
| LPC Cepstrum Coefficients Recognition | 84.3 | 74.1 | 65.0 | 64.9 |
| Rate (%) | | | | |

On the other hand, based on the same experimental data of FIG. 16, the empirical result of our invention below shows our apparatus in accuracy rate has been much improved by our algorithm.

| Precision of Feature Parameters | 32 bit | 8 bit | 6 bit | 4 bit |
|---|---|---|---|---|
| Similarity Vector Recognition Rate (%) | 97.5 | 97.5 | 97.5 | 97.3 |

It is clearly known that, according to these two tables above, recognition rate of our invention is much higher than traditional one. Moreover, our apparatus can get higher accuracy rate even though the extracted parameters are from 4 bits sampling. In almost all traditional approaches, the parameter extraction is used on 32 bits (4 bytes) for feature representation. In our apparatus, however, the parameter can merely be extracted by 4 bits and get high precision.

Although the present invention has been fully described in connection with the preferred embodiment thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A Mandarin Chinese speech recognition method comprising the step of:
training a Phoneme Similarity Vector (PSV) model on the initial part to create an initial part model having trained initial part model parameters;
training a PSV on the final part to create a final part model having trained final part model parameter;
training a PSV on the training speech syllable to create a syllable model using the trained initial part parameter values and the trained final part parameter values as starting parameters for the syllable model;
operating on an object speech sample with the syllable model;
recognizing the object speech sample as an object speech syllable based on a degree of match of the object speech sample to the syllable model; and
representing the object speech sample as a Chinese character in accordance with the object speech syllable.

2. A Mandarin Chinese speech recognition method as in claim 1 further comprising the step of:
training a Dynamic Time Warping (DTW) on a sequence of Chinese characters as used in context to create a Chinese language model;
operating on a sequence of object speech syllables in the object speech sample with the Chinese language model;
representing the object speech sample as a Chinese character sequence in accordance with a match of the sequence of object speech syllables to the Chinese language model; and
representing the object speech sample as a Chinese character sequence in accordance with a sequence of matches to the object speech syllables.

3. A Mandarin Chinese speech recognition apparatus comprising:
a speech signal filter for receiving a speech signal and creating a filtered analogue signal;
an analogue-to-digital (A/D) converter connected to the speech signal to a digital speech signal;
a computer connected to the A/D converter for receiving and processing the digital signal;
a pitch frequency detector connected to the computer for detecting characteristics of the pitch frequency of the speech signal thereby recognizing tone in the speech signal;
a speech signal pre-processor connected to the computer for detecting the endpoints of syllables of speech signals thereby defining a beginning and ending of a syllable; and
a training portion connected to the computer for training an initial part PSV model and a final part PSV model and for training a syllable model based on trained parameters of the initial part PSV model and the final part PSV model.
